(19) United States
(12) Patent Application Publication
(10) Pub. No.: US 2024/0302773 A1
(43) Pub. Date: Sep. 12, 2024

(54) FIXING DEVICE AND IMAGE FORMING APPARATUS INCORPORATING THE SAME

(71) Applicants: Hiroyuki SHIMADA, Tokyo (JP); Yukimichi SOMEYA, Saitama (JP); Yuusuke FURUICHI, Kanagawa (JP)

(72) Inventors: Hiroyuki SHIMADA, Tokyo (JP); Yukimichi SOMEYA, Saitama (JP); Yuusuke FURUICHI, Kanagawa (JP)

(21) Appl. No.: 18/439,784

(22) Filed: Feb. 13, 2024

(30) Foreign Application Priority Data
Mar. 7, 2023 (JP) 2023-034975

(51) Int. Cl. G03G 15/20; G03G 15/00

(52) U.S. Cl. CPC G03G 15/2053; G03G 15/2064; G03G 15/5045

(57) ABSTRACT

A fixing device includes a fixing belt, a planar heater, a pressure rotator, a temperature sensor, and a plate. The pressure rotator presses the planar heater to form a nip through which a sheet is conveyed in a conveyance direction. The plate contacts the planar heater and includes a first portion and a second portion. The first portion has an opening and a projection. The temperature sensor contacts the planar heater through the opening to detect a temperature of the planar heater. The projection projects from the opening in the conveyance direction. The first portion has a first width in the conveyance direction. The second portion is inside a minimum sheet-passing region in an axial direction of the pressure rotator orthogonal to the conveyance direction and outside the first portion in the axial direction and has a second width smaller than the first width in the conveyance direction.

### CROSS-REFERENCE TO RELATED APPLICATION

This patent application is based on and claims priority pursuant to 35 U.S.C. § 119 (a) to Japanese Patent Application No. 2023-034975, filed on Mar. 7, 2023, in the Japan Patent Office, the entire disclosure of which is hereby incorporated by reference herein.

### BACKGROUND

### Technical Field

Embodiments of the present disclosure relate to a fixing device including a planar heater and an image forming apparatus including the fixing device, such as a copier, a printer, a facsimile machine, or a multifunction peripheral having at least two of copying, printing, and facsimile functions.

### Related Art

One type of fixing device in an image forming apparatus such as a copier or a printer in the related art uses a planar heater (a resistive heat generator) as a heating device to heat a fixing belt.

### SUMMARY

This specification describes an improved fixing device that includes a fixing belt, a planar heater, a pressure rotator, a temperature sensor, and a plate. The planar heater heats the fixing belt. The pressure rotator presses the planar heater via the fixing belt to form a fixing nip through which a sheet is conveyed in a conveyance direction. The temperature sensor contacts the planar heater to detect a temperature of the planar heater. The plate contacts the planar heater and includes a first portion and a second portion. The first portion has an opening and a projection. A part of the temperature sensor contacts the planar heater through the opening. The projection projects from the opening in the conveyance direction. The first portion has a first width in the conveyance direction. The second portion is inside a minimum sheet-passing region in an axial direction of the pressure rotator orthogonal to the conveyance direction and outside the first portion in the axial direction and has a second width smaller than the first width in the conveyance direction.

This specification also describes an image forming apparatus including the fixing device.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an overall configuration of an image forming apparatus according to an embodiment of the present disclosure;

FIG. 2 is a diagram illustrating a configuration of a fixing device incorporated in the image forming apparatus of FIG. 1;

FIG. 3 is a cross-sectional view of the fixing device of FIG. 2 as viewed from above to illustrate components extending in a width direction that is a lateral direction of FIG. 3;

FIG. 4 is a schematic cross-sectional view of a fixing belt extending in the width direction and guides included in the fixing device of FIG. 3;

FIG. 5 is an enlarged sectional view of a main part of the fixing device of FIGS. 2 to 4;

FIG. 6 is a view of a thermal equalization plate on a back side of a planar heater according to an embodiment of the present disclosure;

FIG. 7 is a view of a thermal equalization plate on a back side of a planar heater according to a control sample;

FIG. 8 is a view of a thermal equalization plate on a back side of a planar heater according to a first modification of an embodiment of the present disclosure;

FIG. 9 is a view of a thermal equalization plate on a back side of a planar heater according to a second modification of an embodiment of the present disclosure;

FIG. 10A is a view of a thermal equalization plate on a back side of a planar heater according to a third modification of an embodiment of the present disclosure;

FIG. 10B is a side view of the thermal equalization plate of FIG. 10A; and

FIG. 11 is a view of a thermal equalization plate on a back side of a planar heater according to a fourth modification of an embodiment of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

As used herein, the singular forms “a,” “an,” and “the” are intended to include the plural forms as well, unless the context clearly indicates otherwise.

Embodiments of the present disclosure are described below in detail with reference to the drawings. Identical reference numerals are assigned to identical or equivalent components and a description of those components may be simplified or omitted.

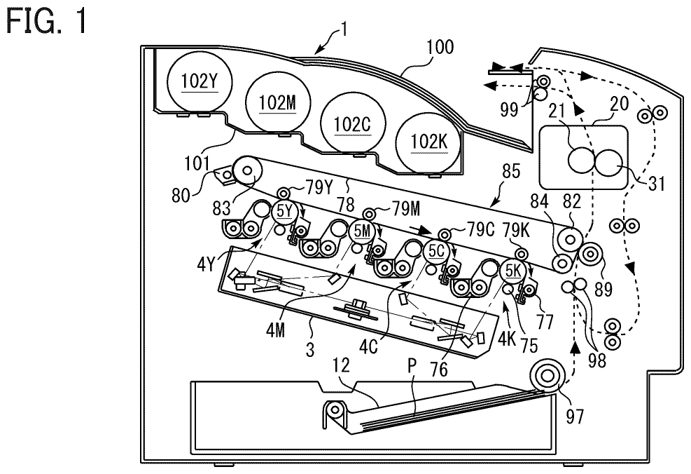

Initially with reference to FIG. 1, a configuration and operation of an image forming apparatus 1 according to an embodiment of the present disclosure is described below.

As illustrated in FIG. 1, the image forming apparatus 1 according to the present embodiment is a tandem-type color printer. The image forming apparatus 1 includes a bottle housing 101 in an upper portion of the image forming apparatus 1. The bottle housing 101 accommodates four toner bottles 102Y, 102M, 102C, and 102K containing fresh yellow, magenta, cyan, and black toners, respectively, and being detachably attached to the bottle housing 101 for replacement.

Under the bottle housing 101, an intermediate transfer unit 85 is disposed. Facing an intermediate transfer belt 78 of the intermediate transfer unit 85, image forming devices 4Y, 4M, 4C, and 4K are arranged side by side to form toner images of yellow, magenta, cyan, and black, respectively.

The image forming devices 4Y, 4M, 4C, and 4K include photoconductor drums 5Y, 5M, 5C, and 5K, respectively. Each of the photoconductor drums 5Y, 5M, 5C, and 5K is surrounded by a charger 75, a developing device 76, a cleaner 77, a discharger. Image forming processes including a charging process, an exposure process, a developing process, a primary transfer process, and a cleaning process are performed on an outer circumferential surface of each of the photoconductor drums 5Y, 5M, 5C, and 5K, forming yellow, magenta, cyan, and black toner images on the photoconductor drums 5Y, 5M, 5C, and 5K, respectively.

A motor drives and rotates the photoconductor drums 5Y, 5M, 5C, and 5K clockwise in FIG. 1. The chargers 75 uniformly charge the surfaces of the photoconductor drums 5Y, 5M, 5C, and 5K, respectively, which is referred to as the charging process.

After the charging process, the charged outer circumferential surface of each of the photoconductor drums 5Y, 5M, 5C, and 5K reaches an irradiation position at which an exposure device 3 irradiates and scans the photoconductor drums 5Y, 5M, 5C, and 5K with laser beams L, irradiating and scanning the photoconductor drums 5Y, 5M, 5C, and 5K with the laser beams L forms electrostatic latent images according to yellow, magenta, cyan, and black image data in the exposure process.

After the exposure process, the irradiated and scanned outer circumferential surface of each of the photoconductor drums 5Y, 5M, 5C, and 5K reaches a developing position at which the developing device 76 is disposed opposite each of the photoconductor drums 5Y, 5M, 5C, and 5K, and the developing device 76 develops the electrostatic latent image formed on the respective photoconductor drums 5Y, 5M, 5C, and 5K, thus forming yellow, magenta, cyan, and black toner images on the photoconductor drums 5Y, 5M, 5C, and 5K in the developing process.

After the developing process, the yellow, magenta, cyan, and black toner images formed on the photoconductor drums 5Y, 5M, 5C, and 5K reach primary transfer nips formed between the photoconductor drums 5Y, 5M, 5C, and 5K and the intermediate transfer belt 78 by four primary transfer bias rollers 79Y, 79M, 79C, and 79K pressed against the four photoconductor drums 5Y, 5M, 5C, and 5K via the intermediate transfer belt 78, respectively, and the yellow, magenta, cyan, and black toner images are primarily transferred onto the intermediate transfer belt 78 in a primary transfer process. After the primary transfer process, residual toner failed to be transferred onto the intermediate transfer belt 78 remains on the photoconductor drums 5Y, 5M, 5C, and 5K slightly.

After the primary transfer process, the residual toner on each of the photoconductor drums 5Y, 5M, 5C, and 5K reaches a cleaning position at which the cleaner 77 is disposed opposite each of the photoconductor drums 5Y, 5M, 5C, and 5K, and a cleaning blade of the cleaner 77 mechanically collects the residual toner from each of the photoconductor drums 5Y, 5M, 5C, and 5K in the cleaning process.

Finally, the cleaned outer circumferential surface of each of the photoconductor drums 5Y, 5M, 5C, and 5K reaches a discharging position at which the discharger is disposed opposite each of the photoconductor drums 5Y, 5M, 5C, and 5K, and the discharger eliminates residual potential from each of the photoconductor drums 5Y, 5M, 5C, and 5K.

Thus, a series of image forming processes performed on the photoconductor drums 5Y, 5M, 5C, and 5K is finished.

The yellow, magenta, cyan, and black toner images formed on the photoconductor drums 5Y, 5M, 5C, and 5K in the developing process are primarily transferred onto an outer circumferential surface of the intermediate transfer belt 78 such that the yellow, magenta, cyan, and black toner images are superimposed on a same position on the intermediate transfer belt 78. Thus, a color toner image is formed on the intermediate transfer belt 78.

The intermediate transfer unit 85 includes the intermediate transfer belt 78, the four primary transfer bias rollers 79Y, 79M, 79C, and 79K, a secondary transfer backup roller 82, a cleaning backup roller 83, a tension roller 84, and an intermediate transfer belt cleaner 80. The intermediate transfer belt 78 is stretched taut across and supported by the three rollers, that is, the secondary transfer backup roller 82, the cleaning backup roller 83, and the tension roller 84. One of the three rollers, that is, the secondary transfer backup roller 82 drives and rotates the intermediate transfer belt 78 in a rotation direction indicated by an arrow in FIG. 1.

The four primary transfer bias rollers 79Y, 79M, 79C, and 79K sandwich the intermediate transfer belt 78 together with the four photoconductor drums 5Y, 5M, 5C, and 5K, respectively, thus forming the four primary transfer nips between the intermediate transfer belt 78 and the photoconductor drums 5Y, 5M, 5C, and 5K. Each of the primary transfer bias rollers 79Y, 79M, 79C, and 79K is applied with a primary transfer bias having a polarity opposite a polarity of electric charge of toner.

The intermediate transfer belt 78 is moved in the direction indicated by the arrow in FIG. 1 and sequentially passes through the primary transfer nips formed by the primary transfer bias rollers 79Y, 79M, 79C, and 79K. The yellow, magenta, cyan, and black toner images on the photoconductor drums 5Y, 5M, 5C, and 5K are primarily transferred to and superimposed on the intermediate transfer belt 78, thereby forming the color toner image.

Subsequently, the intermediate transfer belt 78 bearing the color toner image reaches a position opposite a secondary transfer roller 89. At the position, the secondary transfer backup roller 82 and the secondary transfer roller 89 press against each other via the intermediate transfer belt 78, and the contact portion therebetween is hereinafter referred to as a secondary transfer nip. The four color toner image formed on the intermediate transfer belt 78 is transferred onto the sheet P conveyed to the position of the secondary transfer nip. At this time, untransferred toner that is not transferred onto the sheet P remains on the surface of the intermediate transfer belt 78.

The intermediate transfer belt 78 reaches a position opposite the intermediate transfer belt cleaner 80. At the position, the intermediate transfer belt cleaner 80 collects the untransferred toner from the intermediate transfer belt 78.

Thus, a series of transfer processes performed on the intermediate transfer belt 78 is completed.

The sheet P conveyed through the secondary transfer nip is conveyed from a sheet feeder 12 disposed in a lower portion of the body of the image forming apparatus 1 through a feed roller 97, a registration roller pair 98 (e.g., a timing roller pair).

Specifically, the sheet feeder 12 contains a stack of multiple sheets P such as sheets of paper stacked on one on another. As the feed roller 97 rotates counterclockwise in FIG. 1, the feed roller 97 feeds an uppermost sheet P in the sheet feeder 12 to a roller nip between the registration roller pair 98.

The registration roller pair 98 stops rotating temporarily, stopping the sheet P with a leading edge of the sheet P nipped in the roller nip between the registration roller pair 98. Subsequently, the registration roller pair 98 rotates to convey the sheet P to the secondary transfer nip, timed to coincide with the arrival of the color toner image on the intermediate transfer belt 78. Thus, the desired color toner image is transferred onto the sheet P.

After the secondary transfer roller 89 transfers the color toner image onto the sheet P at the secondary transfer nip, the sheet P is conveyed to a fixing device 20. In the fixing device 20, a fixing belt 21 and a pressure roller 31 apply heat and pressure to the sheet P to fix the transferred color toner image on the sheet P, which is referred to as a fixing process.

After the fixing process, the sheet P bearing the fixed toner image is conveyed through a roller nip formed by an output roller pair 99 and ejected by the output roller pair 99 onto an outside of the image forming apparatus 1. The sheets P ejected by the output roller pair 99 are sequentially stacked as output images on a stack section 100.

Thus, a series of image forming processes performed by the image forming apparatus 1 is completed.

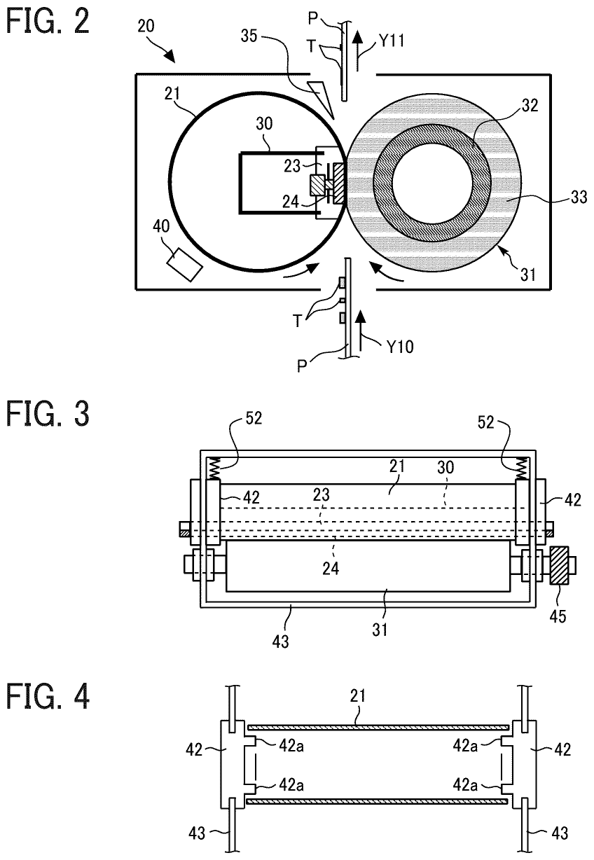

Referring to FIGS. 2 to 4, the following describes a configuration and operation of the fixing device 20 incorporated in the image forming apparatus 1 described above.

The fixing device 20 conveys the sheet P (bearing an unfixed toner image) while heating the sheet P.

With reference to FIGS. 2 to 4, the fixing device 20 includes a fixing belt 21 serving as a fixing rotator, a reinforcement 30, a planar heater 24, a pressure roller 31 serving as a pressure rotator, a temperature sensor 40 as a temperature detector, and a separation plate 35.

The fixing belt 21 is an endless belt disposed in contact with an outer circumferential surface of the pressure roller 31 and driven to rotate by rotation of the pressure roller 31. The fixing belt 21 is a thin, flexible endless belt driven to rotate counterclockwise in FIG. 2, that is, in a rotation direction indicated by an arrow in FIG. 2. The fixing belt 21 includes a base layer having an inner circumferential surface (i.e., a sliding contact surface of the fixing belt 21 sliding over the planar heater 24), an elastic layer coating the base layer, and a release layer coating the elastic layer, which defines a total thickness of the fixing belt 21 not greater than 1 mm.

The base layer of the fixing belt 21 has a thickness in a range of from 30 μm to 50 μm and is made of metal, such as nickel or stainless steel, or resin such as polyimide.

The elastic layer of the fixing belt 21 has a thickness of 100 μm to 300 μm and is made of rubber such as silicone rubber, foamable silicone rubber, or fluoro rubber. The elastic layer absorbs slight surface asperities of the fixing belt 21 at a fixing nip formed between the fixing belt 21 and the pressure roller 31, facilitating even heat conduction from the fixing belt 21 to the color toner image T on the sheet P and thereby suppressing formation of an orange peel image on the sheet P.

The release layer of the fixing belt 21 has a thickness in a range of from 5 μm to 50 μm and is made of material such as tetrafluoroethylene-perfluoroalkyl vinyl ether copolymer (PFA), polytetrafluoroethylene (PTFE), polyimide, polyether imide, and polyether sulfone (PES). The release layer facilitates separation or peeling-off of toner of the color toner image T on the sheet P from the fixing belt 21.

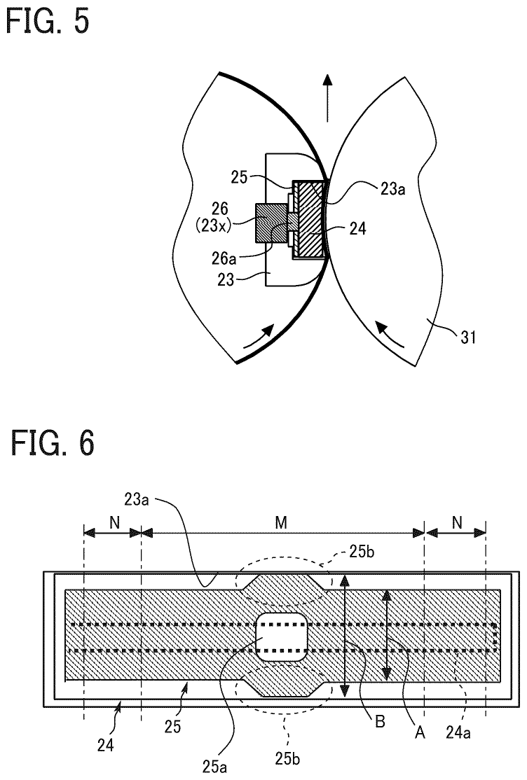

Referring to FIGS. 2 and 5, inside a loop of the fixing belt 21, the planar heater 24, a holder 23, a thermal equalization plate 25, a thermostat 26 as a temperature sensor, a reinforcement 30 are disposed.

The planar heater 24 contacts the inner circumferential surface of the fixing belt 21. The planar heater 24 presses against the pressure roller 31 via the fixing belt 21 to form the fixing nip through which the sheet P is conveyed. The planar heater 24 is disposed inside the loop formed by the fixing belt 21 such that the inner circumferential surface of the fixing belt 21 slides over the planar heater 24. The planar heater 24 presses against the pressure roller 31 via the fixing belt 21 to form the fixing nip between the fixing belt 21 and the pressure roller 31, through which the sheet P is conveyed. As described above, the planar heater 24 functions as a nip formation pad that is a member forming the fixing nip. The planar heater 24 may include a sheet made of low friction material such as PTFE or a surface layer made of the low friction material on the surface of the planar heater 24 or lubricant applied to the surface of the planar heater 24 to reduce sliding friction between the fixing belt 21 and the planar heater 24.

In addition, the planar heater 24 includes a resistor pattern 24a (see FIG. 6) formed on a portion that is in sliding contact with the inner circumferential surface of the fixing belt 21. A power supply supplies electric power to the resistor pattern 24a serving as a resistive heat generator, and the resistor pattern 24a generates heat according to the resistance of the resistor pattern 24a to heat the fixing belt 21. As described above, the planar heater 24 also functions as a heating unit (heating body) that heats the fixing belt 21.

In the present embodiment, the holder 23 holds the planar heater 24 together with the thermal equalization plate 25 and the thermostat 26 (see FIG. 5). As illustrated in FIG. 3, a housing 43 of the fixing device 20 holds both end portions of the holder 23 in a width direction of the holder 23 that is the direction perpendicular to a plane on which FIG. 2 is illustrated and the lateral direction in FIG. 3.

The planar heater 24, the thermal equalization plate 25, the thermostat 26 and the holder 23 is described below in detail with reference to FIGS. 5 to 6.

As described above, the planar heater 24 (the resistor pattern 24a) disposed inside the loop of the fixing belt 21 directly heats the fixing belt 21. The outer circumferential surface of the fixing belt 21 heated by the planar heater 24 heats the toner image T on the sheet P.

Output of the planar heater 24 is controlled based on the temperature of the outer circumferential surface of the fixing belt 21 detected by the temperature sensor 40. The temperature sensor 40 is a thermopile, a thermistor, disposed opposite the outer circumferential surface of the fixing belt 21. The planar heater 24 controlled as described above heats the fixing belt 21 to a desired fixing temperature.

Referring to FIG. 4, a pair of flanges 42 as guides guide ends of the inner circumferential surface of the fixing belt 21 in a width direction of the fixing belt 21 such that the fixing belt 21 maintains a substantially cylindrical posture.

Specifically, the two flanges 42 are made of a heat-resistant resin material and are fitted into both sides in a width direction of the housing 43 of the fixing device 20. Each of the flanges 42 includes a guide 29a and a stopper. The guide 29a supports the fixing belt 21 to maintain the substantially cylindrical posture thereof. The stopper restricts motion or skew of the fixing belt 21 in the width direction thereof.

In addition, as illustrated in FIG. 3, the fixing device 20 according to the present embodiment includes compression springs 52 as biasing members. The biasing force of the compression springs 52 press the flanges 42. As a result, the fixing belt 21, the planar heater 24, and the holder 23 are pressed against the pressure roller 31 by the biasing force.

The flanges 42 support both end portions of the fixing belt 21 in the width direction of the fixing belt 21 except for both end portions corresponding to the fixing nip so that the planar heater 24 can form the fixing nip.

As described above, the inner circumferential surface of the fixing belt 21 is loosely contacted only by the planar heater 24 and the flanges 42 at respective ends of the fixing belt 21 in the width direction thereof. No other component, such as a belt guide, contacts the inner circumferential surface of the fixing belt 21 to guide the fixing belt 21 as it rotates.

The fixing device 20 according to the present embodiment includes the reinforcement 30 that is disposed inside the loop of the fixing belt 21 so as to be in contact with the pressure roller 31 via the holder 23, the planar heater 24, and the fixing belt 21. The reinforcement 30 reinforces the holder 23, the thermal equalization plate 25, and the planar heater 24 forming the fixing nip to enhance the mechanical strength of the holder 23, the thermal equalization plate 25, and the planar heater 24. The reinforcement 30 is installed in the housing 43 by screw fastening.

The reinforcement 30 receiving the pressure from the pressure roller 31 via the holder 23, the planar heater 24, and the fixing belt 21 prevents a disadvantage that the pressure from the pressure roller 31 largely deforms the planar heater 24 (and the holder 23) at the fixing nip. Preferably, the reinforcement 30 is made of metal having an increased mechanical strength, such as stainless steel or iron, to achieve the above-described function.

The holder 23 may be made of a resin material or a metallic material. Preferably, the holder 23 is made of a resin material that has a rigidity to prevent the holder 23 from bending even if the holder 23 receives the pressure from the pressure roller 31, and the resin material preferably has heat resistance and thermal insulation. Such a resin material maybe liquid crystal polymer (LCP), polyamide imide (PAI), polyether sulfone (PES), polyphenylene sulfide (PPS), polyether nitrile (PEN), and polyether ether ketone (PEEK). In the present embodiment, a liquid crystal polymer (LCP) is used as the material of the holder 23.

Referring to FIG. 2, the pressure roller 31 as the pressure rotator includes a cored bar 32 (serving as an axial portion) and an elastic layer 33 coating the cored bar 32. The pressure roller 31 is driven and rotated clockwise in FIG. 2 by a drive motor.

The cored bar 32 of the pressure roller 31 has a hollow structure made of meatal. The elastic layer 33 of the pressure roller 31 is made of material such as foamable silicone rubber, silicone rubber, or fluoro rubber. A thin release layer made of PFA, PTFE may be provided on the surface of the elastic layer 33. The pressure roller 31 is pressed against the fixing belt 21 to form a desired nip between the fixing belt 21 and the pressure roller 31. As illustrated in FIG. 3, a gear 45 is attached to the pressure roller 31 and engages a driving gear of the drive motor so that the pressure roller 31 is driven and rotated clockwise in FIG. 2, that is, a direction indicated by the arrow in FIG. 2. Both ends of the pressure roller 31 in the width direction of the pressure roller 31 are rotatably supported by the housing 43 of the fixing device 20 through bearings, respectively.

Referring to FIG. 2, the separation plate 35 is disposed so as to face a portion of the fixing belt 21 downstream from the fixing nip in the rotation direction of the fixing belt 21. The separation plate 35 prevents the sheet P sent out from the fixing nip from being wound around the fixing belt 21.

In the present embodiment, the edge of the holder 23, the edge adjacent to the planar heater 24 may be projected from the face of the planar heater 24 forming the fixing nip.

In this case, the fixing belt 21 in the vicinity of both ends of the planar heater 24 in a belt moving direction in which the fixing belt 21 moves has an inverted arc shape that projects from the edge of the holder 23 to the planar heater 24. As a result, the inner circumferential surface of the fixing belt 21 is less likely to come into contact with the edges of the planar heater 24 in the belt moving direction. Since the above-described structure reduces the curvature of the cross-sectional shape of the fixing belt 21 in a portion facing the exit of the fixing nip, the above-described structure enhances a sheet separation performance in that the sheet P separates from the fixing belt 21 or the pressure roller 31 at the exit of the fixing nip.

A description is provided of a regular fixing process to fix the toner image T on the sheet P, which is performed by the fixing device 20 having the construction described above.

As the body of the image forming apparatus 1 is powered on, the planar heater 24 is supplied with power and the motor starts driving and rotating the pressure roller 31 clockwise in FIG. 2, that is, in the direction indicated by the arrow in FIG. 2. Accordingly, the pressure roller 31 drives and rotates the fixing belt 21 counterclockwise in FIG. 2 by friction therebetween generated at the fixing nip N.

Thereafter, the sheet P is fed from the sheet feeder 12, the color toner image is transferred onto the sheet P at the position of the secondary transfer roller 89 and becomes the unfixed color image borne on the sheet P. As illustrated in FIG. 2, the sheet P bearing the unfixed toner image T is conveyed in a direction indicated by an arrow Y10 while the sheet P is guided by a guide plate and enters the fixing nip formed between the fixing belt 21 and the pressure roller 31 pressed against the fixing belt 21.

The toner image T is fixed on a surface of the sheet P under heat from the fixing belt 21 heated by the planar heater 24 and pressure exerted from the planar heater 24 (and the holder 23) and the pressure roller 31 pressed against the planar heater 24 supported by the reinforcement 30. Thereafter, the sheet P is ejected from the fixing nip and conveyed in a direction Y11.

The following describes a configuration and an operation of the fixing device 20 in detail. As described above with reference to FIGS. 2 and 5, the fixing device 20 of the present embodiment includes the fixing belt 21, the planar heater 24, and the pressure roller 31 as the pressure rotator. The planar heater 24 heats the fixing belt 21, the fixing belt 21 heats the toner image to fix the toner image on the face of the sheet P. The pressure roller 31 as the pressure rotator is pressed against the planar heater 24 via the fixing belt 21 to form the fixing nip in which the sheet P is conveyed. The planar heater 24 includes the resistor pattern 24a (see FIG. 6), power supply electrodes formed on a base made of an insulating material such as aluminum nitride (AlN) or ceramic.

Referring to FIG. 5, the fixing device 20 according to the present embodiment includes the thermostat 26 as the temperature sensor and the thermal equalization plate 25 that are in contact with the planar heater 24.

The thermostat 26 functions as the temperature sensor that faces the fixing nip via the planar heater 24 and contacts a back side of the planar heater 24 (that is, the left side of the planar heater 24 in FIG. 5) to detect the temperature of the planar heater 24. The thermostat 26 in the present embodiment cuts off the electric power supplied to the planar heater 24 in response to a surface temperature of the planar heater 24 reaching a predetermined temperature to avoid an excessive temperature rise of the planar heater 24 and damage due to the excessive temperature rise.

The thermal equalization plate 25 has thermal conductivity (good thermal conductivity). The thermal equalization plate 25 contacts the back side of the planar heater 24 (that is the left side of the planar heater 24 in FIG. 5). In addition, the thermal equalization plate 25 has an opening 25a (see FIG. 6) to bring a detector 26a of the thermostat 26 as the temperature sensor in contact with the back side of the planar heater 24. Temperatures in the planar heater 24 tend to rise in the vicinity of the resistor pattern 24a that is the resistive heat generator. The thermal equalization plate 25 dissipates heat in the vicinity of the resistor pattern 24a to a portion away from the resistor pattern 24a to uniform the temperature distribution (to reduce the difference in temperature) in the entire region of the planar heater 24 and reduce unevenness of the image fixed to the sheet. The thermal equalization plate 25 may be made of, for example, metal such as copper having excellent thermal conductivity, or graphite. Specifically, the thermal equalization plate 25 is made of a material having a thermal conductivity of 10 W/(m·K) or more at 0° C., and preferably a material having a thermal conductivity of 393 W/(m·K) or more that is the thermal conductivity of cupper. The holder 23 holds the planar heater 24, the thermal equalization plate 25, and the thermostat 26 as the temperature sensor.

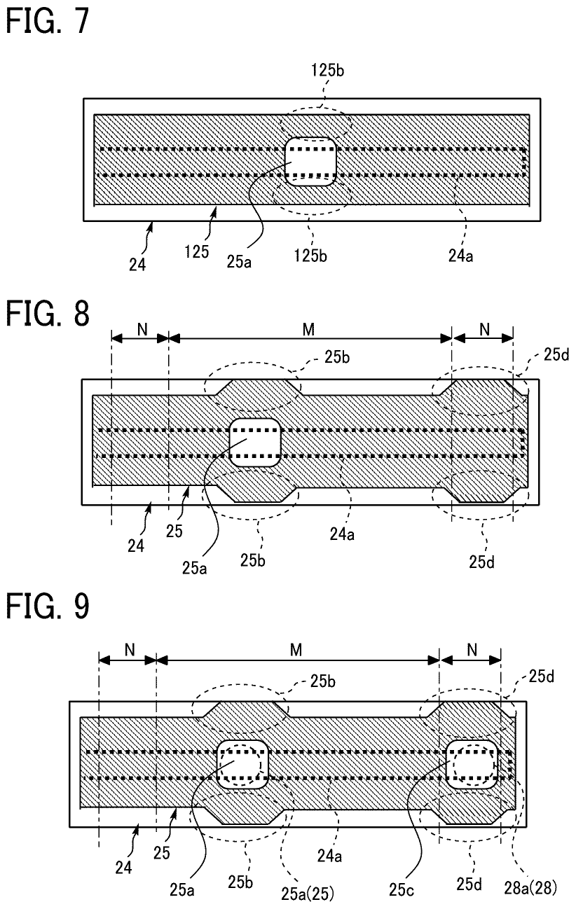

As illustrated in FIG. 6, the thermal equalization plate 25 according to the present embodiment has a contact face in contact with the back side of the planar heater 24. A portion having the contact face has projections 25b projecting in a short-side direction of the thermal equalization plate 25 that is the vertical direction in FIG. 6. The thermal equalization plate 25 has the opening 25a to insert the detector 26a of the thermostat 26, and the projection 25b is formed around the opening 25a. As a result, the thermal equalization plate 25 has a portion having the opening 25a and a width B in the short-side direction and the other portion having a width A smaller than the width B, being inside a minimum sheet-passing region M and outside the opening 25a in a longitudinal direction of the thermal equalization plate 25 that is a lateral direction in FIG. 6, and not having the opening 25a. In other words, the thermal equalization plate 25 includes a first portion having the opening 25a through which the detector 26a of the thermostat 26 contacts the planar heater 24 and a second portion inside the minimum sheet-passing region M and outside the first portion in the axial direction of the pressure roller 31 as the pressure rotator. The first portion has the projection 25b projecting from the opening 25a in a conveyance direction in which the sheet is conveyed. As a result, the first portion has a first width larger than a second width of the second portion in the conveyance direction. FIG. 7 is a view of a thermal equalization plate 125 according to a control sample on the back side of the planar heater 24. The thermal equalization plate 125 has a rectangular shape. In contrast, the thermal equalization plate 25 is not formed to be the rectangular shape. The thermal equalization plate 25 has the projections 25b formed in the vicinity of the portion having the opening 25a to insert the detector 26a of the thermostat 26, the projections 25b projecting from both sides of the opening 25a in the short-side direction toward the outside of the opening 25a in the short-side direction. As described above, the detector 26a of the thermostat 26 is disposed inside the minimum sheet-passing region M and detects the temperature of the planar heater 24 inside the minimum sheet-passing region M. The above-described structure enables always detecting the temperature of the planar heater 24 inside a sheet passing region of a sheet of sheets having various widths.

The “minimum sheet-passing region M” described above means a region in the width direction of the sheet in the fixing device 20 and the region facing the minimum sheet having the smallest width of widths of sheets P that can pass through the image forming apparatus 1. In other words, the minimum sheet-passing region faces a region in which a sheet having the smallest width of widths of sheets used in the fixing device passes. The fixing device 20 according to the present embodiment can fix the image onto the sheet P corresponding to a maximum sheet-passing region (M+2N) in addition to the sheet P corresponding to the minimum sheet-passing region M as illustrated in FIG. 6. The planar heater 24 has a heat generation area corresponding to the maximum sheet-passing region (M+2N) in the width direction that is the lateral direction in FIG. 6.

As described above, the thermal equalization plate 25 according to the present embodiment has the first portion formed in the vicinity of the opening 25a and having the width B in the short-side direction larger than the width A of the second portion in the short-side direction inside the minimum sheet-passing region M.

The thermal equalization plate illustrated as the control sample in FIG. 7 has the rectangular shape and portions 125b each having an extremely narrow width in the short-side direction, but the thermal equalization plate 25 according to the present embodiment does not have a portion like the portion 125b. In other words, the projection 25b in the thermal equalization plate 25 according to the present embodiment can increase the width of the portion in the vicinity of the opening 25a in the short-side direction.

The above-described structure is less likely to impair an ability to disperse the heat around the opening 25a and to cause a decrease in the strength of the thermal equalization plate 25.

In order to further exert the above-described effect, the projection 25b is preferably formed so that the distances (in other words, the widths) between an edge (in other words, an end) of the projection 25b and the opening 25a are as uniform as possible as illustrated in FIG. 6. The distance (in other words, the width) is preferably designed as large as possible within the range of layout constraints.

Referring to FIGS. 5 and 6, the holder 23 in the present embodiment has an abutted portion 23a and an opening 23x.

The holder 23 has an accommodating recess into which the planar heater 24 and the thermal equalization plate 25 are inserted. The accommodating recess has four inner walls. The abutted portion 23a is one of four inner walls on the downstream side in the conveyance direction of the sheet P indicated by an arrow in an upper part of FIG. 5. The planar heater 24 and the thermal equalization plate 25 are abutted against the abutted portion 23a.

The planar heater 24 and the thermal equalization plate 25 are abutted against the abutted portion 23a and fixed to the holder 23 by screw fastening. The screw fastening positions the planar heater 24 and the thermal equalization plate 25 on the holder 23 in the conveyance direction (that is also the rotation direction of the fixing belt 21).

Abutting the planar heater 24 and the thermal equalization plate 25 against the abutted portion 23a that is the downstream side inner wall of the holder 23 in the conveyance direction that is also the rotation direction of the fixing belt 21 to position the planar heater 24 and the thermal equalization plate 25 as described above prevents positional deviations of the planar heater 24 and the thermal equalization plate 25 even when the fixing belt 21 rotating in the rotation direction applies force to the planar heater 24 and the thermal equalization plate 25. As a result, a stable fixing process can be performed.

Referring to FIG. 5, the opening 23x of the holder 23 is a through hole formed to penetrate the holder 23 from the back side of the holder 23 toward the bottom of the accommodating recess into which the planar heater 24 and the thermal equalization plate 25 are inserted. The thermostat 26 as the temperature sensor is abutted on a downstream side of the opening 23x in the conveyance direction that is also the rotation direction of the fixing belt. The thermostat 26 abutted on the downstream side of the opening 23x is fixed to the holder 23 by screw fastening or another fastening method. As a result, the thermostat 26 is positioned on the holder 23 in the conveyance direction that is also the rotation direction of the fixing belt 21.

The direction to abut the thermostat 26 on the downstream side of the opening 23x in the conveyance direction that is also the rotation direction of the fixing belt to position the thermostat 26 is the same as the direction to abut the planar heater 24 and the thermal equalization plate 25 on the abutted portion 23a to position the planar heater 24 and the thermal equalization plate 25. As a result, the above-described structure is less likely to cause a disadvantage that the detector 26a of the thermostat 26 does not fit in the opening 25a of the thermal equalization plate 25 and a disadvantage that the thermostat contacts the planar heater 24 at a position displaced from the target contact position.

As illustrated in FIG. 6, the projection 25b of the thermal equalization plate 25 in the present embodiment, which is the upper projection 25b in FIG. 6, is abutted against the abutted portion 23a of the holder 23.

Abutting the projection 25b having a short length (in other words, a short contact width) in the longitudinal direction against the abutted portion 23a to position the thermal equalization plate 25 enables maintaining a higher positional accuracy than abutting a long portion of the thermal equalization plate 25 in the longitudinal direction (for example, an entire side face of the thermal equalization plate 25 extending in the longitudinal direction) against the abutted portion 23a to position the thermal equalization plate 25.

The following describes a first modification of the present embodiment.

As illustrated in FIG. 8, the fixing device 20 according to the first modification of the present embodiment of the present disclosure includes the thermal equalization plate 25 having second projections 25d. The second projection 25d is in a region N outside the minimum sheet-passing region M in the longitudinal direction. The opening 25a is not formed in the region N on which the second projections 25d are formed. In other words, the thermal equalization plate 25 further includes a third portion outside the minimum sheet-passing region M and outside the opening in the axial direction of the pressure roller, and the third portion has the second projection 25d projecting toward the inner wall of the holder to abut against the inner wall of the holder in the conveyance direction. The shape of the second projection 25d is the same as the shape of the projection 25b, which is referred to as a first projection 25b in the first modification. A width of the region N on which the second projections 25d are formed in the short-side direction is designed to be the width B (see FIG. 6).

The first projection 25b and the second projection 25d that are in the thermal equalization plate 25 are abutted against the abutted portion 23a of the holder 23. In other words, abutting the two projections, which are the first projection 25b and the second projection 25d, against the abutted portion 23a positions the thermal equalization plate 25 with respect to the holder 23 in the first modification.

The above-described structure can create a better balance in positioning the thermal equalization plate 25 with respect to the holder 23 in the longitudinal direction than the structure in which abutting the projection 25b against the abutted portion 23a to position the thermal equalization plate 25 with respect to the holder 23.

In order to enhance the above-described effect, the first projection 25b (and the thermostat 26 and the opening 25a) in the first modification is away from the second projection 25d but is inside the minimum sheet-passing region M to position the thermal equalization plate 25 in the longitudinal direction in a well-balanced manner.

The following describes a second modification of the present embodiment.

As illustrated in FIG. 9, the fixing device 20 according to the second modification includes the thermal equalization plate 25 having the second projections 25d, similarly to the thermal equalization plate 25 illustrated in FIG. 8. The thermal equalization plate 25 according to the second modification has a second opening 25c having the same shape as the opening 25a, which is referred to as a first opening 25a in the second modification. The second opening 25c is formed in the region N outside the minimum sheet-passing region M in the longitudinal direction that is the axial direction of the pressure roller. The first opening 25a is not formed in the region N.

The fixing device 20 according to the second modification includes a second thermostat 28 as a second temperature sensor contacting the back side of the planar heater 24 through the second opening 25c. The second thermostat 28 is the same type of the thermostat 26, which is referred to as a first thermostat 26 in the second modification. The holder 23 holds the second thermostat 28 in addition to the first thermostat 26.

A detector 28a of the second thermostat 28 as the second temperature sensor contacts a portion of the planar heater 24 in the region N through the second opening 25c to detect the temperature of the portion of the planar heater in the region N.

Continuously passing the sheets P having the smallest size corresponding to the minimum sheet-passing region M through the fixing device is more likely to cause the excessive temperature rise in the portion of the planar heater 24 in a non-sheet-passing region N than a portion of the planar heater 24 in the minimum sheet-passing region M because the sheets P do not absorb heat from the portion of the planar heater 24 in the non-sheet-passing region. The second thermostat 28 functions to detect the above-described excessive temperature rise.

The following describes a third modification.

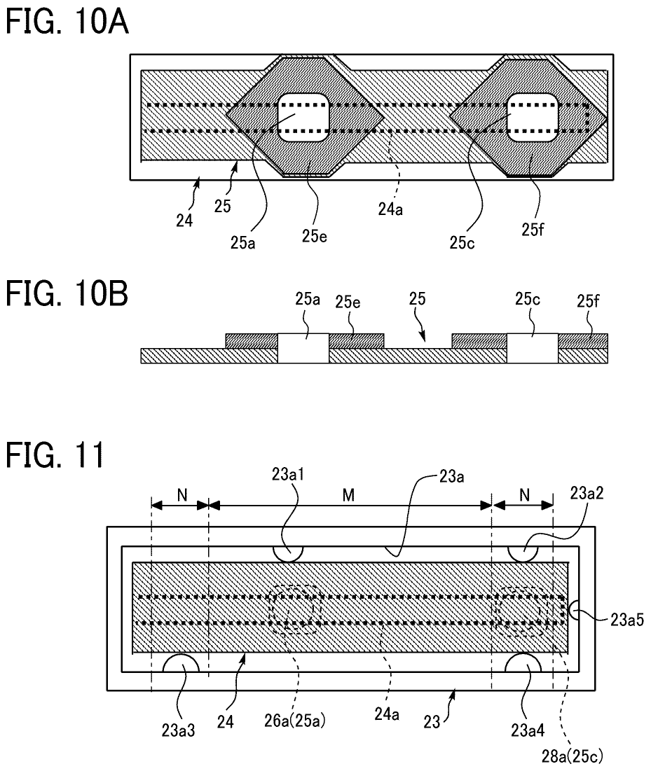

As illustrated in FIGS. 10A and 10B, the fixing device 20 according to the third modification includes the thermal equalization plate 25 having a larger plate thickness in a portion around the first opening 25a (and the second opening 25c) than another portion of the thermal equalization plate 25.

Specifically, the thermal equalization plate 25 includes a laminated layer 25e formed in a portion around the first opening 25a, and this portion has a two layer structure. Similarly, the thermal equalization plate 25 includes a laminated layer 25f formed in a portion around the second opening 25c, and this portion has a two layer structure. The laminated layers 25e and 25f are made of the same material as the material of the thermal equalization plate 25 other than the laminated layers 25e and 25f. The thermal equalization plate 25 other than the laminated layers 25e and 25f forms a base layer (in other words, a lower layer). In other words, the thermal equalization plate 25 includes the first portion, the second portion, and the third portion, and each of the first plate thickness of the first portion and the third plate thickness of the third portion is larger than the second plate thickness of the second portion.

Forming the plate thickness around the first opening 25a and the second opening 25c to be thick as described above further enhances the ability to disperse the heat around the openings and further increase the strength of the thermal equalization plate 25.

The following describes a fourth modification.

As illustrated in FIG. 11, the fixing device 20 according to the fourth modification includes protrusions 23a1 and 23a2. The protrusions 23a1 and 23a2 are formed on the abutted portion 23a of the holder 23 to contact the planar heater 24.

Specifically, the holder 23 has the accommodating recess into which the planar heater 24 is inserted as described above, and multiple protrusions 23a3 to 23a5 and the protrusions 23a1 and 23a2 protrude from the inner peripheral wall face of the holder 23 to inward. The protrusions 23a1 to 23a5 each have a hemispherical shape and come into point contact with the end face of the planar heater 24. In particular, the planar heater 24 is abutted against the two protrusions 23a1 and 23a2 formed on the side of the abutted portion 23a is fixed to the holder 23 by screw fastening or another fastening method. As a result, the planar heater 24 is accurately positioned.

In particular, in the fourth modification, the positions of the protrusions 23a1 and 23a2 on the abutted portion 23a in the longitudinal direction substantially coincide with the positions of the detector 26a of thermostat 26 and the detector 28a of the thermostat 28 in the longitudinal direction as illustrated in FIG. 11. In other words, the protrusion 23a1 overlaps the opening 25a in the axial direction, and the protrusion 23a2 overlaps the opening 25c in the axial direction.

As a result, in addition to the planar heater 24, the detector 26a of the thermostat 26 and the detector 28a of the thermostat 28 are accurately positioned in the holder 23.

As described above, the fixing device 20 according to the present embodiment includes the planar heater 24, the fixing belt 21, the pressure roller 31 as the pressure rotator, the thermostat 26, and the thermal equalization plate 25. The planar heater 24 heats the fixing belt 21, and the fixing belt 21 heats the toner image to fix the toner image onto the face of the sheet. The pressure roller 31 is pressed against the planar heater 24 via the fixing belt 21 to form the fixing nip through which the sheet P is conveyed. The thermostat 26 as the temperature sensor contacts the back side of the planar heater 24 so as to face the fixing nip via the planar heater 24 to detect the temperature of the planar heater 24. The thermal equalization plate 25 has thermal conductivity, contacts the back side of the planar heater 24, and has the opening 25a to bring the thermostat 26 in contact with the back side of the planar heater 24. The thermal equalization plate 25 has the contact face in contact with the back side of the planar heater 24. The portion having the contact face has projections 25b projecting in the short-side direction. The projection 25b is formed around the opening 25a. As a result, the thermal equalization plate 25 has the portion having the opening 25a and the width B in the short-side direction and the other portion having the width A smaller than the width B and being inside the minimum sheet-passing region M and outside the opening 25a in the longitudinal direction.

The above-described structure is less likely to impair the ability of the thermal equalization plate 25 to disperse the heat and to cause the decrease in the strength of the thermal equalization plate 25.

In the fixing devices described above, the pressure roller 31 is used as a pressure rotator. Alternatively, a pressure belt may be used as a pressure rotator.

In such configurations, similar effects to the embodiments described above are also attained.

The above-described embodiments are illustrative and do not limit this disclosure. Thus, numerous additional modifications and variations are possible in light of the above teachings. For example, elements at least one of features of different illustrative and exemplary embodiments herein may be combined with each other at least one of substituted for each other within the scope of this disclosure and appended claims. The number, position, and shape of the components described above are not limited to those embodiments described above. Desirable number, position, and shape can be determined to perform the present disclosure.

In the present disclosure, the width direction is defined as a direction orthogonal to the conveyance direction in which the sheet is conveyed and parallel to the rotational axial direction of the fixing belt or the pressure rotator.

Aspects of the present disclosure are, for example, as follows.

### First Aspect

In a first aspect, a fixing device includes a fixing belt, a planar heater, a pressure rotator, a temperature sensor, and a plate. The planar heater heats the fixing belt. The pressure rotator presses the planar heater via the fixing belt to form a fixing nip through which a sheet is conveyed in a conveyance direction. The temperature sensor contacts the planar heater to detect a temperature of the planar heater. The plate contacts the planar heater and includes a first portion and a second portion. The first portion has an opening and a projection. A part of the temperature sensor contacts the planar heater through the opening. The projection projects from the opening in the conveyance direction. The first portion has a first width in the conveyance direction. The second portion is inside a minimum sheet-passing region in an axial direction of the pressure rotator orthogonal to the conveyance direction and outside the first portion in the axial direction and has a second width smaller than the first width in the conveyance direction.

### Second Aspect

In a second aspect, the fixing device according to the first aspect further includes a holder holding the planar heater, the plate, and the temperature sensor, and the holder has an opening and a wall. The opening positions the temperature sensor with respect to the holder in the conveyance direction. The wall contacts the planar heater and the projection of the plate in the conveyance direction to position the planar heater and the plate in the conveyance direction.

### Third Aspect

In a third aspect, the plate in the fixing device according to the second aspect includes a third portion outside the minimum sheet-passing region and outside the opening in the axial direction, and the third portion has another projection projecting toward the wall to abut against the wall in the conveyance direction.

### Fourth Aspect

In a fourth aspect, the fixing device according to the third aspect further includes another temperature sensor, and the third position of the plate has another opening through which a part of said another temperature sensor contacts the planar heater.

### Fifth Aspect

In a fifth aspect, the wall of the holder in the fixing device according to any one of the second to fourth aspects includes a protrusion contacting the planar heater.

### Sixth Aspect

In a sixth aspect, the protrusion in the fixing device according to the fifth aspect overlaps the opening in the axial direction.

### Seventh Aspect

In a seventh aspect, the first portion in the fixing device according to any one of the first to sixth aspects has a first plate thickness larger than a second plate thickness of the second portion.

### Eighth Aspect

In an eighth aspect, an image forming apparatus includes the fixing device according to any one of the first to seventh aspects.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. A fixing device comprising:
a fixing belt;
a planar heater to heat the fixing belt;
a pressure rotator pressing the planar heater via the fixing belt to form a fixing nip through which a sheet is conveyed in a conveyance direction;
a temperature sensor contacting the planar heater to detect a temperature of the planar heater; and
a plate contacting the planer heater, the plate including:
a first portion having:
an opening through which a part of the temperature sensor contacts the planar heater; and
a projection projecting from the opening in the conveyance direction, and
the first portion having a first width in the conveyance direction; and
a second portion inside a minimum sheet-passing region in an axial direction of the pressure rotator orthogonal to the conveyance direction and outside the first portion in the axial direction,
the second portion having a second width smaller than the first width in the conveyance direction.

2. The fixing device according to claim 1, further comprising:
a holder holding the planar heater, the plate, and the temperature sensor,
wherein the holder has:
an opening to position the temperature sensor with respect to the holder in the conveyance direction; and
a wall contacting the planar heater and the projection of the plate in the conveyance direction to position the planar heater and the plate in the conveyance direction.

3. The fixing device according to claim 2,
wherein the plate further includes:
a third portion outside the minimum sheet-passing region and outside the opening in the axial direction, and
the third portion has another projection projecting toward the wall to abut against the wall in the conveyance direction.

4. The fixing device according to claim 3, further comprising
another temperature sensor,
wherein the third portion of the plate has another opening through which a part of said another temperature sensor contacts the planar heater.

5. The fixing device according to claim 2,
wherein the wall of the holder includes a protrusion contacting the planar heater.

6. The fixing device according to claim 5,
wherein the protrusion overlaps the opening in the axial direction.

7. The fixing device according to claim 1,
wherein the first portion has a first plate thickness larger than a second plate thickness of the second portion.

8. An image forming apparatus comprising the fixing device according to claim 1.
